(19) United States
(12) Patent Application Publication
(10) Pub. No.: US 2008/0088767 A1
(43) Pub. Date: Apr. 17, 2008

(54) Backlight module and liquid crystal display with same

(75) Inventors: Fei-Hong Chen, Shenzhen (CN); Chih-Hung Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/974,828

(22) Filed: Oct. 16, 2007

(30) Foreign Application Priority Data
Oct. 16, 2006 (TW) 95138073

(51) Int. Cl. F21V 8/00; G02F 1/1333

(52) U.S. Cl. 349/58; 362/621

(57) ABSTRACT

An exemplary backlight module (20) has a light guide plate (24), and a frame (28) receiving the light guide plate. The light guide plate has a light incident surface (244), two side walls (241, 242) respectively adjoining the light incident surface. The frame has two grooves (288, 289) corresponding the two side walls. Each side wall of the light guide plate has a protrusion part (250) and a plane surface part (247) between the light incident surface and the protrusion part, the protrusion part is received in the corresponding groove, which has a length in a range from one third to two third the length of each corresponding side wall.

### FIELD OF THE INVENTION

The present invention relates to backlight modules such as those used in liquid crystal displays (LCDs), and more particularly to a light guide plate configured to be stably and compactly retained in a frame of a backlight module of a light crystal display (LCD) device.

### GENERAL BACKGROUND

Liquid crystal displays are commonly used as displays for compact electronic apparatuses, because they not only provide good quality images with little power but are also very thin. The liquid crystal in a liquid crystal display does not emit any light itself. The liquid crystal has to be lit by a light source so as to clearly and sharply display text and images. Thus, a backlight module is generally needed for a liquid crystal display.

Referring to FIG. 9, a typical liquid crystal display (LCD) 1 is disclosed. The LCD device 1 includes an LCD panel 11, and a backlight module 12 arranged under the LCD panel 11. The backlight module 12 provides light beams to illuminate the LCD panel 11, so that the LCD panel 11 can display images.

The backlight module 12 includes an upper brightness enhancement film 130, a bottom brightness enhancement film 132, a diffusion sheet 134, a light guide plate 14, a plurality of light sources 16, a frame 18, and a reflective plate 15. The light guide plate 14 includes a light incident surface 144, a light output surface 146 adjoining the light incident surface 144, a bottom surface 148 opposite to the light output surface 146 and two opposite side surfaces 141, 142. Each side surface 141, 142 has two ears 147 formed thereon. The frame 18 has four concave grooves 187, corresponding to four ears 147, and a light source disposition region 185 for receiving the light source 16.

After assembly, the frame 18 receives the light guide plate 4 and the light sources 16 therein. The concave grooves 187 respectively receive the ears 147. Thereby, the light guide plate 14 is received and supported by the frame 18. The light source 16 is accommodated in the light source disposition region 185. The upper brightness enhancement film 130, the bottom brightness enhancement film 132, and the diffusion sheet 134 are arranged or the light output surface 142 of the light guide plate 14 in that order from top to bottom. The light sources 16 are arranged adjacent to the light incident surface 144, and the reflective plate 15 is arranged adjacent to the bottom surface 148.

On the one hand, to make the backlight module 12 stable, the ears 147 can be made to have a same thickness as that of the light guide plate 14, and the frame 18 can be made to be a little thicker than the ears 147. However, this configuration means that the backlight module 12 has an increased thickness. On the one hand, to make the backlight module 12 thin, the ears 147 can be made to be thinner than the light guide plate 14. However, with this configuration, it is difficult to manufacture the ears 147, and the strength of the ears 147 is reduced. If one or more of the ears 147 fractures or breaks, the backlight module 12 may become unstable. In addition, following the technical development, the liquid guide plate 14 is designed with a thinner thickness, such as 0.4 millimeter, or 0.3 millimeter. And, the ear 147 needs to be designed with a thinner thickness too, which decreases the mechanical strength. This may result in the ear 147 being distorted or even damaged in the moving or assembling process. When this occurs, the mechanical stability and the performance of the backlight module 12 are liable to be impaired.

What is needed, therefore, is a backlight module that can overcome the above-described deficiency. What is also needed is a liquid crystal display including the backlight module.

### SUMMARY

In one preferred embodiment, a backlight module has a light guide plate, and a frame receiving the light guide plate. The light guide plate has a light incident surface, two side walls respectively adjoining the light incident surface. The frame has two grooves corresponding the two side walls. Each side wall of the light guide plate has a protrusion part and a plane surface part between the light incident surface and the protrusion part, the protrusion part is received in the corresponding groove, which has a length in a range from one third to two third the length of each corresponding side wall.

In Another preferred embodiment, a liquid crystal display has a liquid crystal panel, a light guide plate, and a frame receiving the light guide plate and the liquid crystal panel. The light guide plate has a light incident surface, two side walls respectively adjoining the light incident surface. The frame has two grooves corresponding the two side walls. Each side wall of the light guide plate has a protrusion part and a plane surface part between the light incident surface and the protrusion part, the protrusion part is received in the corresponding groove, which has a length in a range from one third to two third the length of each corresponding side wall.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is an exploded, isometric view of a liquid crystal display according to a first embodiment of the present invention, which has a light guide plate.

FIG. 2 is a schematic, isometric view of the light guide plate of FIG. 1.

FIG. 3 is a cross-sectional view of the light guide plate taken along line III-III of FIG. 2.

FIG. 4 is an assembly view of the backlight module of FIG. 1.

FIG. 5 is an exploded, isometric view of a light guide plate of a liquid crystal display according to a second embodiment of the present invention.

FIG. 6 is a cross-sectional view of the light guide plate taken along line VI-VI of FIG. 5.

FIG. 7 is an exploded, isometric view of a light guide plate of a liquid crystal display according to a third embodiment of the present invention.

FIG. 8 is a cross-sectional view of the light guide plate taken along line VIII-VIII of FIG. 7.

FIG. 9 is an exploded, isometric view of a conventional backlight module.

### DETAILED DESCRIPTION OF PREFERRED EMBODIMENTS

Reference will now be made to the drawings to describe the preferred embodiments in detail.

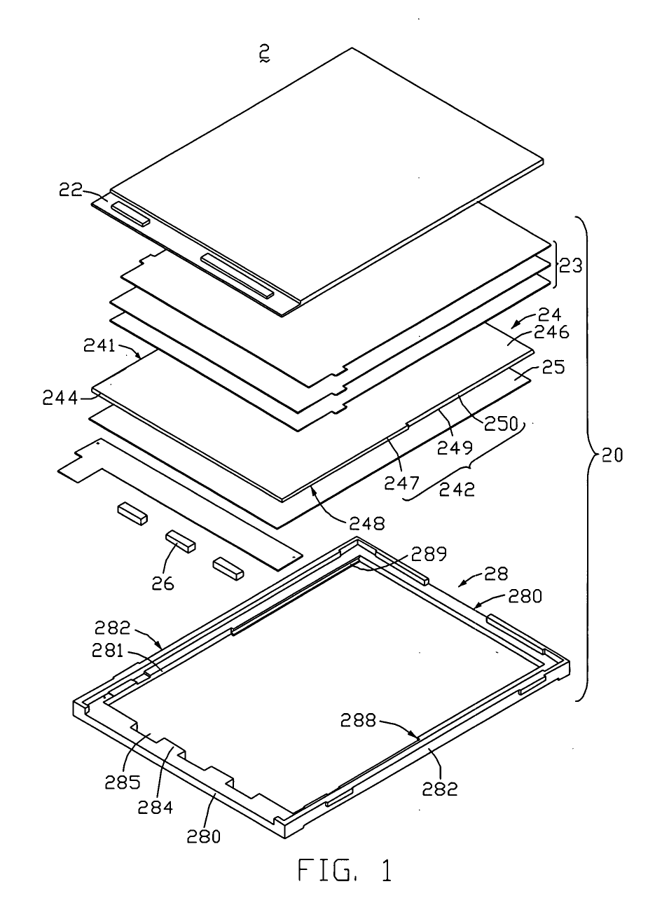

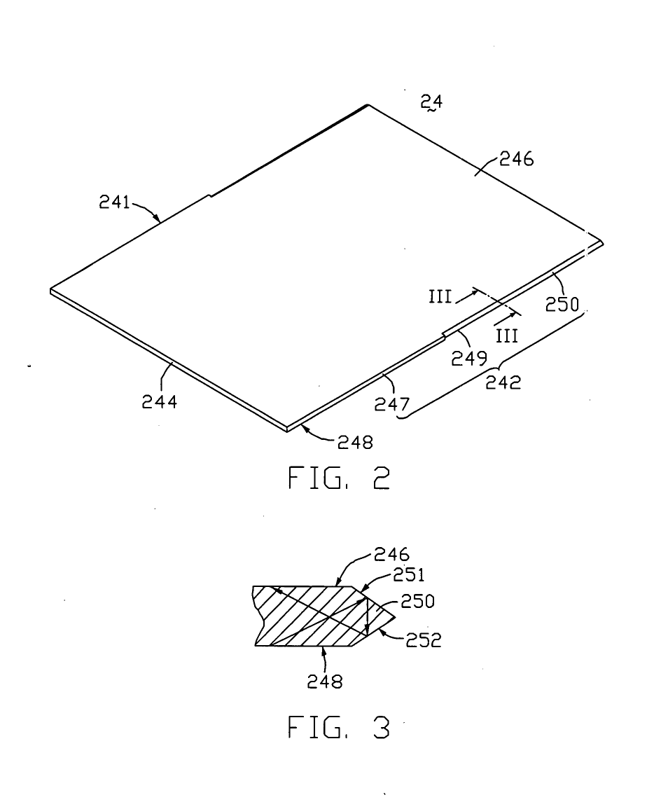

Referring to FIG. 1, a liquid crystal display 21 according to a first embodiment of the present invention is shown. The liquid crystal display 2 includes a liquid crystal panel 22, and a backlight module 20 located adjacent to the liquid crystal panel 22. The backlight module 20 is used to provide uniform surface light to the liquid crystal panel 22.

The backlight module 20 includes an optical films assembly 23, a light guide plate 24, a light source 26, and a frame 28 receiving the light guide plate 24, the light source 26 and the optical films assembly 23. The light guide plate 24 includes a light incident surface 244, a light emitting surface 246, a bottom surface 248, a first side wall 241, and a second side wall 242. The light emitting surface 246 is perpendicularly connected with the light incident surface 244. The bottom surface 248 is on an opposite side of the light guide plate 24 to the light emitting surface 246. The first side wall 241 and the second side wall 242 are on opposite sides of the light guide plate 24 to each other, and are perpendicularly connected with the light incident surface 244, the light emitting surface 246, and the bottom surface 248. That is, the light incident surface 244, the first side wall 241, and the second side wall 242 are positioned between the light emitting surface 244 and the bottom surface 248. Each of the first and the second side walls 241, 242 has a first part 247 adjacent and perpendicular to the light incident surface 244, and a second part 249 far away the light incident surface 244. That is the first part 247 is formed between the second part 249 and the light incident surface 244. The distance between the two opposite first parts 247 of the first and the second side walls 241, 242 is little larger than that of the two opposite second parts 249 of the first and the second side walls 241, 242. The second part 249 has a length in a range of from one-thirds to two-thirds the length of the corresponding first and the second side walls 241, 242. In addition, a protrusion 250 is formed on the second part 249, which has a same length to that of the second part 249, covering the whole surface of the second part 249. Each of protrusion 250 at two side walls 241, 242 has an isosceles triangle profile. Each protrusion 250 defines a two-dimensional inmost extremity (not labeled) where it integrally extends from the second part 249 of the side wall 241, 242, a lower surface 252 obliquely adjoining the inmost extremity, and an upper surface 251 obliquely adjoining the inmost extremity and adjoining the lower surface. That is, the protrusion 250 is wedge-shaped, with the lower surface 252 and the upper surface 251 having a same size and adjoining the inmost extremity surface at a same oblique angle. When the light beams from the light source 26 transmit to the second part 249, their optical path can be changed by the V-shaped protrusion. That is the light beams can be reflected back to a display region of the light guide plate for reuse (as shown in FIG. 3).

The frame 28 has a substantially rectangular shape, and includes two first side walls 280 located opposite to each other, two second side walls 282 located opposite to each other, and a supporting board 281. The first side walls 280 and the second side walls 282 are connected end to end, and the first side walls 280 are essentially perpendicular to the second side walls 282. The supporting board 281 is generally frame-shaped, and integrally adjoins inner surfaces (not labeled) of the first side walls 280 and the second side walls 282. Thus the frame 28 defines a generally rectangular space (not labeled) for accommodating the light guide plate 24 and supporting the liquid crystal panel 22. Two protrusions 284 are formed adjacent to one of the first side walls 280 at the supporting board 281. The protrusions 284 extend into the space, and are parallel to each other, thereby defining three recesses 285. That is a light source disposition region. The light source 26 of the backlight module 20 are respectively positioned in the recesses 285.

The frame 20 further defines a first sliding groove 288, and a second sliding groove 289. The first sliding groove 288 and the second sliding groove 289 are defined in two opposite sides of the supporting board 281 adjacent to the second side walls 282 respectively. The first and the second sliding grooves 288, 289 are substantially V-shaped, corresponding to the triangle-shaped protrusions 250 at the first and the second side walls 241, 242 of the light guide plate 24. The frame 20 is preferably made from polycarbonate, plastic, or another suitable material.

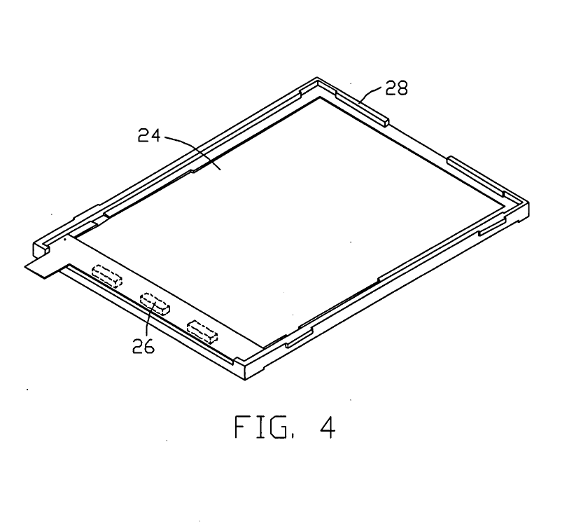

Referring to FIG. 4, an assembly view of the frame 28 and the light guide plate 24 of the liquid crystal display 2 is shown. The light guide plate 24 is accommodated in the frame 28 through the cooperation of the sliding grooves 288, 289 of the frame 28 and the triangle-shaped protrusions 250. Because the triangle-shaped protrusion 250 has a length in a range of from one-thirds to two-thirds the length of the corresponding first and the second side walls 241, 242, it can stably fix the light guide plate 24. Thus, even the light guide plate 24 needs to be thinner, the backlight module 20 still has a high stability. In addition, the V-shaped protrusion 250 can reflect the light beams to the first and the second side walls 241, 247 back to the display region of the light guide plate. Thus, the light beams can be reused and the light utilization ratio is improved. Moreover, the height of the inmost extremity of each protrusion 2501, the same as that of the side surface 241, 242, which enables the protrusion 250 to have good mechanical strength even when the light guide plate 24 is very thin. Similarly, each protrusion can have good mechanical strength even when the light guide plate is very thin. The corresponding groove 288, 289 of the frame 280 is wedge-shaped in a configuration complementary to the sedge shape of the protrusion 250. That is, a height of the groove 288, 289 of the frame 28 progressively decreases from an inmost end thereof to an outmost end thereof. Correspondingly, a height of the frame 28 at the groove 288, 289 progressively increases from the inmost end of the groove 288, 289 to the outmost end of the groove 288, 289. This enables a portion of the frame 28 at the groove 288, 289 to have relatively high mechanical strength. Similarly, portions of the frame 28 at the grooves 288, 289 corresponding to the protrusions 250 also can have relatively high mechanical strength. Thus the frame 28 overall has good mechanical strength. Thus, the frame 28 overall has good mechanical strength. For all these reasons, the backlight module 20 can have good mechanical strength even if the light guide plate 24 is very thin.

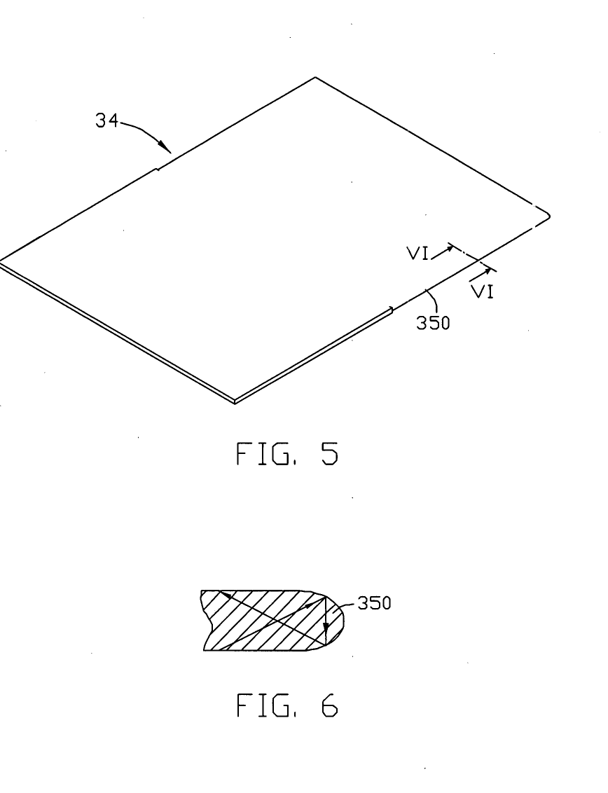

Referring to FIGS. 5 and 6, a light guide plate 34 of a liquid crystal display according to a second embodiment of the present invention is shown, which is similar to the light guide plate 24. However, each of two second parts 349 of two opposite side walls is a protrusion having a semicircle-shaped cross-section. Correspondingly, a sliding groove (not shown) of a frame (not shown) for receiving the semicircle-shaped protrusion has a semicircle-shaped cross-section.

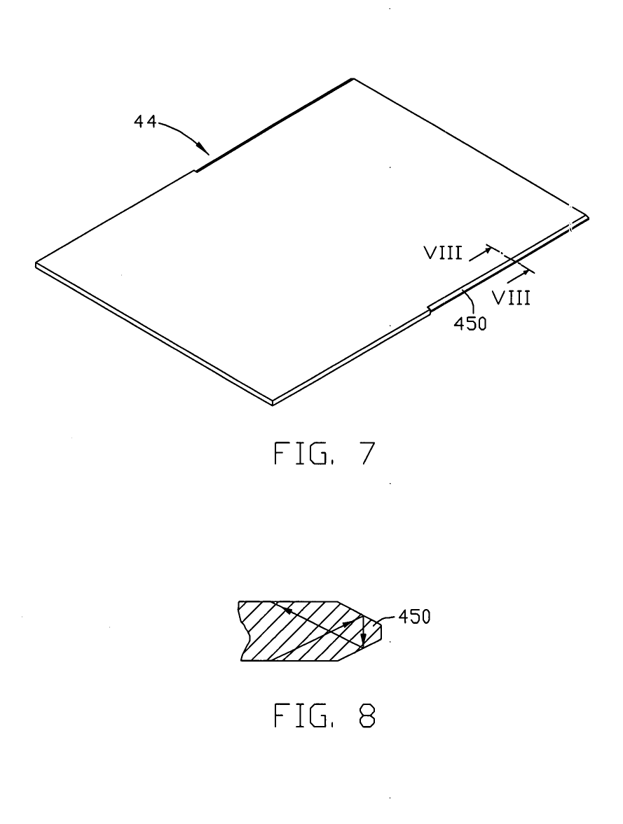

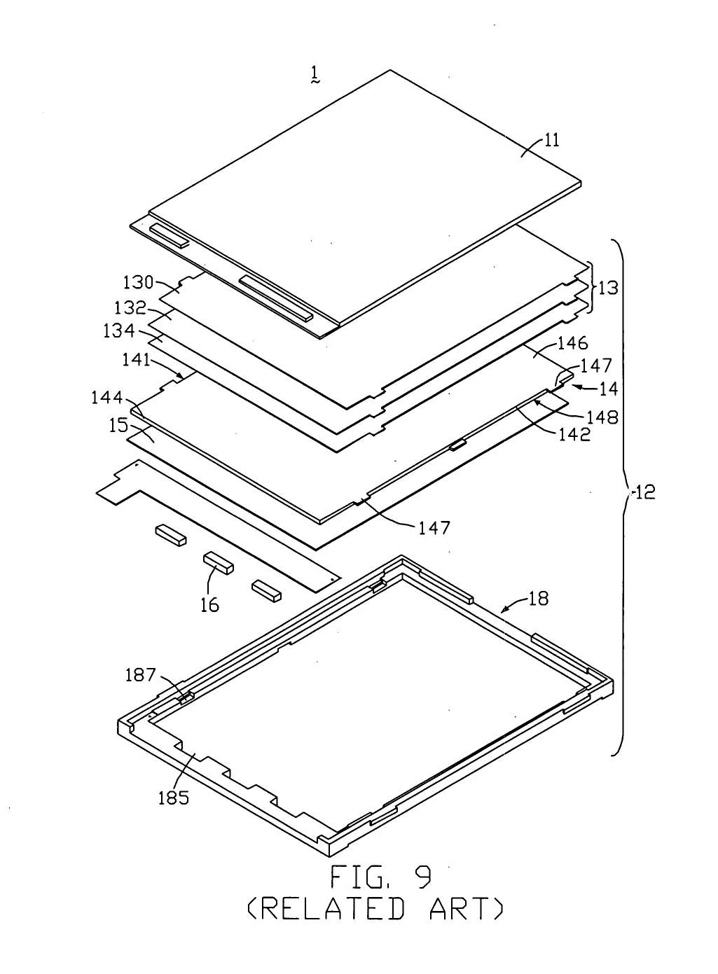

Referring to FIGS. 7 and 8, a light guide plate 44 of a liquid crystal display according to a second embodiment of the present invention is shown, which is similar to the light guide plate 24. However, each of two second parts 449 of two opposite side walls is a protrusion having a trapezium-shaped cross-section. Correspondingly, a sliding groove (not shown) of a frame (not shown) for receiving the protrusion has a trapezium-shaped cross-section.

Further or alternative embodiments may include the following. In one example, the frame defines only one sliding groove adjacent one of the first side wall. In a further example, the light guide plate includes only one or more ears outwardly extending from only one side thereof.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate, which comprises a light incident surface, two side walls respectively adjoining the light incident surface; and
a frame receiving the light guide plate, which comprises two grooves corresponding the two side walls;
wherein each side wall of the light guide plate comprises a protrusion part and a plane surface part between the light incident surface and the protrusion part, the protrusion part is received in the corresponding groove, which has a length in a range from one third to two third the length of each corresponding side wall.

2. The backlight module in claim 1, wherein the protrusion and the groove respectively have a V-shaped cross section.

3. The backlight module in claim 1, wherein the protrusion and the groove respectively have a semicircle cross section.

4. The backlight module in claim 1, wherein the protrusion and the groove respectively have a trapezium cross section.

5. The backlight module in claim 1, further comprising a light source.

6. The backlight module in claim 5, wherein the frame further defines a light source disposition region for receiving the light source.

7. The backlight module in claim 1, wherein the protrusion is two third length of the side wall.

8. A liquid crystal display comprising:
a liquid crystal panel;
a light guide plate, which comprises a light incident surface, two side walls respectively adjoining the light incident surface; and
a frame receiving the light guide plate, which comprises two grooves corresponding the two side walls;
wherein each side wall of the light guide plate comprises a protrusion part and a plane surface part between the light incident surface and the protrusion part, the protrusion part is received in the corresponding groove, which has a length in a range from one third to two third the length of each corresponding side wall.

9. The liquid crystal display in claim 8, wherein the protrusion and the groove respectively have a V-shaped cross section.

10. The liquid crystal display in claim 8, wherein the protrusion and the groove respectively have a semicircle cross section.

11. The liquid crystal display in claim 8, wherein the protrusion and the groove respectively have a trapezium cross section.

12. The liquid crystal display in claim 8, further comprising a light source.

13. The liquid crystal display in claim 12, wherein the frame further defines a light source disposition region for receiving the light source.

14. The liquid crystal display in claim 8, wherein the protrusion is two third length of the side wall.
